(19) United States
(12) Patent Application Publication
(10) Pub. No.: US 2024/0186590 A1
(43) Pub. Date: Jun. 6, 2024

(54) CONDUCTIVE HOT MELT ADHESIVE, CONDUCTIVE INSULATING TAPE, AND BATTERY

(71) Applicant: ZHUHAI COSMX BATTERY CO., LTD., Zhuhai (CN)

(72) Inventors: Wenrong LIN, Zhuhai (CN); Suli LI, Zhuhai (CN); Zhaohua MO, Zhuhai (CN); Junyi LI, Zhuhai (CN); Fei HE, Zhuhai (CN); Wei HUANG, Zhuhai (CN)

(73) Assignee: ZHUHAI COSMX BATTERY CO., LTD., Zhuhai (CN)

(21) Appl. No.: 18/527,011

(22) Filed: Dec. 1, 2023

(30) Foreign Application Priority Data
Dec. 5, 2022 (CN) 202211546625.9

(51) Int. Cl. H01M 10/42; C09J 7/00; C09J 9/02; C09J 11/04; C09J 11/06; C09J 175/06; H01M 50/586; H01M 50/595

(52) U.S. Cl. CPC H01M 10/4235; C09J 7/00; C09J 9/02; C09J 11/04; C09J 11/06; C09J 175/06; H01M 50/586; H01M 50/595; C08K 5/09; C09J 2203/33; C09J 2301/304; C09J 2301/314; C09J 2423/00; C09J 2467/00; C09J 2475/00; H01M 2200/10

(57) ABSTRACT

Disclosed are a conductive hot melt adhesive, a conductive insulating tape, and a battery, where the conductive hot melt adhesive includes a matrix and a conductive filler. A Vicat softening temperature of the conductive hot melt adhesive ranges from 60° C. to 130° C., and the conductive hot melt adhesive is solid in a first state and may soften and flow in a second state. The conductive hot melt adhesive is disposed between a positive electrode component and a negative electrode component of a battery. When a temperature is lower than the Vicat softening temperature of the conductive hot melt adhesive, the positive and negative electrode components cannot be conducted via the conductive hot melt adhesive; when the temperature is higher than the Vicat softening temperature, the conductive hot melt adhesive softens and flows, thereby conducting the positive and negative electrode components.

### CROSS-REFERENCE TO RELATED APPLICATIONS

This application claims priority to Chinese Patent Application No. 202211546625.9, filed on Dec. 5, 2022, which is incorporated herein by reference in its entirety.

### TECHNICAL FIELD

The present disclosure pertains to the field of battery technologies, and more specifically, to a conductive hot melt adhesive, a conductive insulating tape, and a battery.

### BACKGROUND

Secondary batteries are widely used in many fields due to advantages such as high power density and long battery life. When a battery is used in a high-load state such as high power and high current, or in a condition of high temperature, a lot of heat is generated inside the battery, thereby causing a temperature of the battery to rise. If the battery continues to be in such a state, an internal chemical system of the battery will further deteriorate, a thermal runaway occurs, thereby causing an accident such as a fire or explosion of the battery. How to prevent a battery from catching fire or exploding during use of the battery, and ensure safety performance of the battery is always the focus and difficulty of battery manufacturers in research and development.

To solve the foregoing problems, it is proposed that a negative temperature coefficient (Negative Temperature Coefficient, NTC) component is disposed in a battery cell, for example, an NTC component is disposed between positive and negative tabs of a battery, or an NTC component is disposed in a foil uncoating region of an electrode plate, or an NTC component is embedded in a separator. The NTC component may be used to discharge a battery when the battery is abused in high temperature, to reduce voltage and energy of the battery, thereby reducing a risk of thermal diffusion and improving safety performance of the battery. However, the NTC component causes slow discharge of the battery and loses capacity. In addition, the NTC component is added to the battery cell. Because a component is added, an additional process and cost are introduced. The NTC component also occupies space inside the battery, which affects power density of the battery. In addition, embedding the NTC component into a separator further causes an impedance surge of the separator in a normal temperature state, which further affects the C-rate and discharge performance of the battery.

Therefore, a solution for improving battery safety performance without using an NTC component is urgently needed.

### SUMMARY

The objectives of the present disclosure are to provide a conductive hot melt adhesive, a conductive insulating tape including the conductive hot melt adhesive, and a battery using the conductive hot melt adhesive or the conductive insulating tape. When the conductive hot melt adhesive is used in a battery, safety performance of the battery can be improved.

To achieve the foregoing objectives, the following technical solutions are adopted in a first aspect of the present disclosure: a conductive hot melt adhesive, including: a matrix and a conductive filler, where the matrix is a mixture of one or more of polyolefin, benzoic acid, vanillin, azobenzene, polyester, polyurethane, polyamide, or paraffin, and the conductive filler is at least one of carbon, an elemental metal, an alloy, a metal oxide, or a conductive non-metal compound. A Vicat softening temperature of the conductive hot melt adhesive ranges from 60° C. to 130° C. The conductive hot melt adhesive has a first state and a second state, where the conductive hot melt adhesive is solid in the first state and may soften and flow in the second state.

The following technical solutions are adopted in a second aspect of the present disclosure: a conductive insulating tape, including an insulating substrate layer and a conductive hot melt adhesive layer located on a surface of one or two sides of the insulating substrate layer, where the conductive hot melt adhesive layer includes the conductive hot melt adhesive according to the first aspect of the present disclosure.

The following technical solutions are adopted in a third aspect of the present disclosure: a battery, including the conductive hot melt adhesive according to the first aspect.

The following technical solutions are adopted in a fourth aspect of the present disclosure: a battery, includes the conductive insulating tape according to the second aspect.

It may be learned from the foregoing technical solutions that a conductive hot melt adhesive is designed in the present disclosure, which can be applied to a battery and has a Vicat softening temperature ranging from 60° C. to 130° C. The conductive hot melt adhesive is disposed between a positive electrode component and a negative electrode component of the battery. The conductive hot melt adhesive has two states: a solid state and a softened flow state. When a temperature is lower than the Vicat softening temperature of the conductive hot melt adhesive, the conductive hot melt adhesive is in the solid state, and the positive and negative electrode components cannot be conducted via the conductive hot melt adhesive; when the temperature is equal to or higher than the Vicat softening temperature, the conductive hot melt adhesive may soften and flow, thereby conducting the positive and negative electrode components of the battery. In this way, the battery may achieve quick discharging by means of short circuit caused by flowing conductive hot melt adhesive, a voltage and energy of the battery are quickly reduced to a safe threshold, accidents such as fire and explosion caused by thermal runaway of the battery are effectively prevented, and the safety performance of the battery is improved. In addition, compared with an NTC component, the conductive hot melt adhesive may be disposed in any location of the battery according to a requirement without increasing a quantity of battery components. This controls costs and does not occupy too much space inside the battery, thereby reducing impact on power density of the battery.

### BRIEF DESCRIPTION OF THE DRAWINGS

To describe embodiments of the present disclosure more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram in which a conductive hot melt adhesive in Preparation Example 2 is attached to an insulating substrate layer according to the present disclosure.

FIG. 2 is a schematic diagram applied in Example group C1 in which a conductive insulating tape is attached to an end of a wound battery cell according to the present disclosure.

FIG. 3 is a schematic diagram applied in Example group C2 in which a conductive insulating tape is attached to a foil uncoating region of an electrode plate of a laminated battery cell according to the present disclosure.

FIG. 4 is a schematic diagram applied in Example group C3 in which a conductive insulating tape is attached between a positive soft tab and a negative soft tab of a battery cell according to the present disclosure.

FIG. 5 is a schematic diagram applied in Example group C3 in which a conductive hot melt adhesive is attached to an insulating substrate layer according to the present disclosure.

FIG. 6 is a schematic diagram applied in Example group C4 in which a conductive insulating tape is attached between a positive tab and a negative tab of a battery according to the present disclosure.

FIG. 7 is a schematic diagram applied in Example group C5 in which a separator is replaced with a conductive hot melt adhesive according to the present disclosure.

### DETAILED DESCRIPTION OF THE EMBODIMENTS

The following describes the present disclosure in detail with reference to the accompanying drawings. When the embodiments of the present disclosure are described in detail, for ease of description, an accompanying drawing that indicates a structure of a component is not partially enlarged according to a general proportion, and the schematic diagram is merely an example, and should not be construed as limiting the protection scope of the present disclosure. It should be noted that the accompanying drawings are in a simplified form and use a non-accurate proportion, and are merely used to conveniently and clearly assist with the purpose of the embodiments of the present disclosure. In addition, in the description of the present application, the terms “first”, “second”, and the like are merely intended for distinctive description, and shall not be understood as an indication or implication of relative importance or implicit indication of the number of indicated technical features. The orientations or positional relationships indicated by the terms “positive”, “negative”, “bottom”, “upper”, “lower”, and the like are based on the orientations or positional relationships shown in the accompanying drawings. Such terms are intended merely for the ease and brevity of description of the present disclosure without indicating or implying that the apparatuses or components mentioned must have specified orientations or must be constructed and operated in the specified orientations, and therefore shall not be construed as any limitations on the present disclosure.

In the description of the present disclosure, it should be noted that, unless otherwise specified and defined explicitly, the terms “join” and “connect” should be understood in a broad sense, for example, may be a fixed connection, a detachable connection, or an integrated connection; or may be a mechanical connection or an electrical connection; or may be a direct connection, or an indirect connection through an intermediate medium; or may be an internal connection between two components, which may be a wireless connection, or a wired connection. A person of ordinary skills in the art may understand specific meanings of the foregoing terms in the present disclosure as appropriate to specific situations.

A first aspect of the present disclosure provides a conductive hot melt adhesive, including: a matrix and a conductive filler, where the matrix is a mixture of one or more of polyolefin, benzoic acid, vanillin, azobenzene, polyester, polyurethane, polyamide, or paraffin, and the conductive filler is at least one of carbon, an elemental metal, an alloy, a metal oxide, or a conductive non-metal compound. A Vicat softening temperature of the conductive hot melt adhesive ranges from 60° C. to 130° C. The conductive hot melt adhesive has a first state and a second state, where the conductive hot melt adhesive is solid in the first state and may soften and flow in the second state.

In an example, using a total weight of the conductive hot melt adhesive as a reference, a weight content of the matrix ranges from 5% to 60% (for example, 5%, 10%, 15%, 20%, 25%, 30%, 35%, 40%, 45%, 50%, 55%, 60% or a value in a range formed by any two endpoints), and a weight content of the conductive filler ranges from 40% to 95% (for example, 40%, 50%, 55%, 60%, 65%, 70%, 75%, 80%, 85%, 90%, 95% or a value in a range formed by any two endpoints).

In an example, a weight ratio of the matrix to the conductive filler is (0.05-2):1, for example, is 0.05:1, 0.15:1, 0.3:1, 0.5:1, 0.8:1, 0.90:1, 1:1, 1.1:1, 1.2:1, 1.3:1, 1.4:1, 1.5:1, 1.6:1, 1.7:1, 1.8:1, 1.9:1, or 2:1.

A Vicat softening temperature of the conductive hot melt adhesive ranges from 60° C. to 130° C., for example, is 60° C., 70° C., 80° C., 90° C., 100° C., 110° C., 120° C., 130° C. or a value in a range formed by any two points. In an example, the Vicat softening temperature of the conductive hot melt adhesive layer ranges from 90° C. to 110° C. The Vicat softening temperature is measured by using a Vicat softening temperature tester (for a test method, refer to GB/T1633-2000 A₅₀ method).

In an example, the matrix is a substance that may soften and flow at a high temperature, for example, is a substance that may be transformed from a solid to a liquid at a temperature ranging from 60° C. to 130° C.

In the present disclosure, “a plurality of” means two or more.

In an example, the matrix may be a single component, or may be a mixture of two or more components.

In an example, the matrix is a mixture of two or more components.

In an example, the matrix includes one or more types of polyolefin.

In an example, the matrix includes a combination of polyolefin and polyester in a weight ratio of (1.5-5):1 (for example, 1.5:1, 2:1, 3:1, 4:1, or 5:1).

In an example, a weight proportion of the polyolefin and/or the polyester in the matrix is 50% or more (for example, 50%, 60%, 70%, 80%, 90%, or 100%).

In an example, the polyolefin is selected from one or more of an olefin homopolymer and an olefin copolymer, and the olefin homopolymer is, for example, one or more of polyethylene, polypropylene, polybutylene, or polypentene. The olefin copolymer is, for example, one or more of an ethylene-vinyl acetate copolymer, an ethylene-acrylic acid copolymer, a propylene-vinyl acetate copolymer, a propylene-acrylic acid copolymer, or a butylene-vinyl acetate copolymer.

In an example, the polyester includes one or more of polyethylene terephthalate (PET), polybutylene terephthalate (PBT), polyarylester, poly(p-benzophenone-butylene terephthalate), or polylactic acid polyester.

In an example, the matrix includes a combination of one or more of polyolefin or polyamide. The polyamide, for example, is selected from one or more of polyamide 6, polyamide 11, or polyamide 12. Using a total weight of the matrix as a reference, a weight content of the polyamide ranges from 0% to 20% (for example, 0% (namely, absent), 5%, 10%, 15%, 20%, 25%, or 30%).

In an example, the matrix includes a combination of polyolefin of and polyurethane. Using the total weight of the matrix as a reference, a weight content of polyurethane ranges from 0% to 30% (for example, 0% (namely absent), 5%, 10%, 15%, 20%, 25%, or 30%).

In an example, the matrix may further include paraffin. Using the total weight of the matrix as a reference, a weight content of paraffin ranges from 0% to 80% (for example, 0% (namely, absent), 5%, 10%, 20%, 30%, 40%, 50%, 60%, 70%, or 80%).

In an example, the matrix may further include benzoic acid. Using the total weight of the matrix as a reference, a weight content of benzoic acid ranges from 0% to 50% (for example, 0% (namely, absent), 5%, 10%, 15%, 20%, 25%, 30%, 40%, or 50%).

In an example, the matrix may further include vanillin. Using the total weight of the matrix as a reference, a weight content of vanillin ranges from 0% to 80% (for example, 0% (namely, absent), 5%, 10%, 20%, 30%, 40%, 50%, 60%, 70%, or 80%).

In an example, the matrix may further include azobenzene. Using the total weight of the matrix as a reference, a weight content of azobenzene ranges from 0% to 30% (for example, 0% (namely, absent), 5%, 10%, 15%, 20%, 25%, or 30%).

An average molecular weight of the matrix may be in a range from 300 Da to 20000 Da, for example, is 300, 500, 1000, 2000, 5000, 8000, 10000, 12000, 13000, 15000, 18000, 20000, or a value in a range formed by any two points. In the present disclosure, the term “average molecular weight” is calculated based on number-average molecular weight.

In an example, the matrix includes one or more of the following combinations:
a combination of polypropylene and paraffin in a weight ratio of 1:(0.5-0.8);
a combination of propylene-acrylic acid copolymer and polyurethane in a weight ratio of 1:(0.2-0.7);
a combination of polyethylene and vanillin in a weight ratio of 1:(0.5-1.0);
a combination of polypropylene, paraffin, and vanillin in a weight ratio of 1:(0.2-0.8):(0.1-0.5);
a combination of propylene-acrylic acid copolymer, polyurethane, and paraffin in a weight ratio of 1:(0.2-0.8):(0.2-0.8);
a combination of polyethylene, azobenzene, benzoic acid, and POE elastomer in a weight ratio of 1:(0.2-0.8):(0.1-0.5):(0.5-1);
a combination of polyethylene, polyamide 6, POE elastomer, and paraffin in a weight ratio of 1:(0.2-0.8):(0.2-0.8):(0.2-0.8);
a combination of polyethylene, polypropylene, polybutylene, and polyurethane in a weight ratio of 1:(0.8-1.2):(0.8-1.2):(0.5-1); or
a combination of polyethylene, polypentene, propylene-acrylic acid copolymer in a weight ratio of 1:(0.2-0.8):(0.2-0.8).

The conductive filler is, for example, selected from at least one of carbon, an elemental metal, an alloy, a metal oxide, or a conductive non-metal compound.

The conductive filler may be a single component, or may be a mixture of two or more components.

In an example, the conductive filler is a mixture of two or more components.

In an example, the conductive filler includes a combination of carbon and the elemental metal in a weight ratio of (0.2-5):1 (for example, 0.2:1, 0.4:1, 0.6:1, 0.8:1, 1:1, 2:1, 3:1, 4:1, or 5:1).

In an example, a sum of weights of the carbon and the elemental metal accounts for 50% or more of the conductive filler (for example, 50%, 60%, 70%, 75%, 80%, 85%, 90%, 95% or 100%).

In an example, the conductive filler further includes a combination of the metal oxide and the conductive non-metal oxide in a weight ratio of (0.2-5):1 (for example, 0.2:1, 0.4:1, 0.6:1, 0.8:1, 1:1, 2:1, 3:1, 4:1, or 5:1).

The carbon may be a mixture of one or more of conductive carbon black, carbon nanotubes, graphene, graphite, or graphite nanoparticles. The conductive carbon black may be one or more of acetylene carbon black, superconductive carbon black N293, special conductive carbon black N472, superconductive carbon black BP2000, or Japanese superconductive carbon black CB3100.

The elemental metal may be at least one of gold, silver, platinum, copper, aluminum, nickel, zinc, or tin.

The alloy may be at least one of brass, white copper, bronze, silver-aluminum alloy, copper-silver alloy, nickel-aluminum alloy, silver-plated copper, silver-plated aluminum, or silver-plated zinc.

The metal oxide may be an aluminum oxide, a copper oxide, a nickel oxide, a zinc oxide, a calcium oxide, a rare earth metal oxide, or a composite oxide of two or more metals.

The conductive non-metal compound may be at least one of a carbon compound, a silicon compound, a nitrogen compound, a selenium compound, or a carbon-nitrogen compound.

In an example, the conductive filler is in a powder form. In other words, the conductive filler is at least one of carbon, elemental metal powder, alloy powder, metal oxide powder, or conductive non-metal compound powder.

In an example, a crystal particle diameter D1 of the conductive filler meets: 0.01 μm≤D1≤ 50 μm, for example, D1 is 0.01 μm, 0.1 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50 μm or a value in a range formed by any two points. The crystal particle diameter D1 is Dv10.

In an example, a viscosity of the conductive hot melt adhesive at 130° C. ranges from 2500 cps to 8000 cps, for example, is 2500 cps, 3000 cps, 3500 cps, 4000 cps, 4500 cps, 5000 cps, 5500 cps, 6000 cps, 6500 cps, 7000 cps, 7500 cps, 8000 cps, or a value in a range formed by any two points. The viscosity is measured by using a cylindrical rotational viscometer (for the test method, refer to the industry standard HG/T 3660-1999).

In an example, a resistance of the conductive hot melt adhesive at 85° C. ranges from 0.01Ω to 100Ω, for example, is 0.01 Ω, 1 Ω, 5 Ω, 10 0, 15 Ω, 20 Ω, 30 Ω, 40 02, 50 Ω, 60 Ω, 70 Ω, 80 Ω, 90 Ω, 100Ω, or a value in a range formed by any two points. The resistance is measured by using a resistance tester.

The conductive hot melt adhesive includes a matrix and a conductive filler, and is formed by evenly mixing the matrix and the conductive filler. The matrix has an adhesive effect, and is configured to bind the conductive filler together to form a conductive path, so as to implement a conductive connection between regions contacted by the conductive hot melt adhesive. The conductive filler is bound by the matrix. In the present disclosure, a Vicat softening temperature of the conductive hot melt adhesive ranges from 60° C. to 130° C. The conductive hot melt adhesive has two states: a first state and a second state, where the first state is a solidified state at normal temperature, and the second state is a softening flow state at a high temperature (when a temperature reaches the Vicat softening temperature), that is, the conductive hot melt adhesive may soften and flow when the temperature is equal to or higher than the Vicat softening temperature. In both states, the conductive filler can form a conductive path under the adhesive effect of the matrix, so that the conductive hot melt adhesive has electrical conductivity. An amount ratio of the matrix to the conductive filler in the conductive hot melt adhesive is adjusted depending on materials selected for the matrix and the conductive filler. When different materials are selected for the matrix and the conductive filler, an amount ratio of the two materials is also different. In the present disclosure, an amount ratio of the two materials is not limited, and a desired Vicat softening temperature may be reached by dispensing a molecular weight, a melting point, a ratio, and the like of a material, to maintain electrical conductivity of the conductive hot melt adhesive.

In an example, the conductive hot melt adhesive further includes another additive conventional in the art, for example, includes one or more of a toughening agent, a coupling agent, a heat stabilizer, an antioxidant, or a surfactant.

In an example, a content of the additive ranges from 5 to 50 parts by weight based on 100 parts by weight of a total weight of the matrix and the conductive filler, for example, is 1, 5, 8, 10, 12, 15, 18, or 20 parts by weight.

In an example, the toughening agent may include one or more of a thermoplastic elastomer, an ethylene propylene rubber, or a nitrile rubber. An amount of the toughening agent ranges from 0.5 to 10 parts by weight based on 100 parts by weight of a total weight of the matrix and the conductive filler, for example, is 0.5, 1, 2, 3, 5, 8, or 10 parts by weight.

In an example, the coupling agent may include one or more of a silane coupling agent, a titanate coupling agent, an aluminate coupling agent, a phosphate coupling agent, or a borate coupling agent. An amount of the coupling agent ranges from 0.5 to 10 parts by weight based on 100 parts by weight of a total weight of the matrix and the conductive filler, for example, is 0.5, 1, 2, 3, 5, 8, or 10 parts by weight.

In an example, the antioxidant may include one or more of a thiobiophenol antioxidant, an amine antioxidant, or an organic sulfur antioxidant. An amount of the antioxidant ranges from 0.5 to 10 parts by weight based on 100 parts by weight of a total weight of the matrix and the conductive filler, for example, is 0.5, 1, 2, 3, 5, 8, or 10 parts by weight.

In an example, the heat stabilizer may include one or more of an organotin stabilizer, an organolead stabilizer, or a calcium soap. An amount of the heat stabilizer ranges from 0.5 to 10 parts by weight based on 100 parts by weight of a total weight of the matrix and the conductive filler, for example, is 0.5, 1, 2, 3, 5, 8, or 10 parts by weight.

In an example, the surfactant may include one or more of silicate, phosphate, carboxylate, triethylhexyl phosphate, sodium dodecyl sulfate, methyl pentanol, a cellulose derivative, polyacrylamide, guar gum, fatty acid polyethylene glycol ester, xylene, ethylene glycol, or glycerol. An amount of the heat stabilizer ranges from 1 to 30 parts by weight based on 100 parts by weight of a total weight of the matrix and the conductive filler, for example, is 1, 2, 3, 5, 8, 10, 15, 20, 25, or 30 parts by weight.

By doping one or more of the foregoing additives, mixing uniformity of the matrix and the conductive filler can be improved, and/or use stability and a service life of the conductive hot melt adhesive can be improved.

A second aspect of the present disclosure provides a conductive insulating tape, including an insulating substrate layer and a conductive hot melt adhesive layer located on a surface of one or two sides of the insulating substrate layer, where the conductive hot melt adhesive layer includes the conductive hot melt adhesive according to the first aspect of the present disclosure.

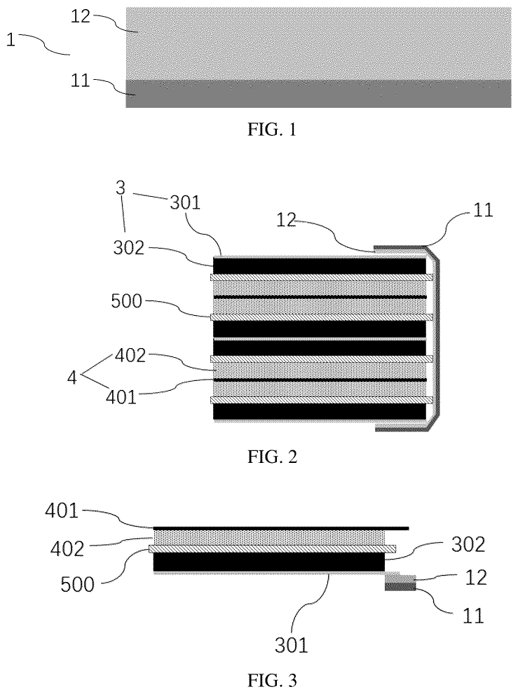

As shown in FIG. 1, a conductive hot melt adhesive 12 may be attached to an insulating substrate layer 11 for use. When the insulating substrate layer 11 and the conductive hot melt adhesive 12 are compounded and applied to a battery, the insulating substrate layer 11 itself is not electrically conductive, and provides the conductive hot melt adhesive 12 with a function of skeleton supporting. The conductive hot melt adhesive 12 is disposed on the insulating substrate layer 11, and the insulating substrate layer 11 is configured to keep the conductive hot melt adhesive 12 in a specific initial state and continuous conductivity by means of wettability between the insulating substrate layer 11 and the conductive hot melt adhesive 12.

The insulating substrate layer in the present disclosure is a high molecular polymer layer, and does not have electrical conductivity. A material of the insulating substrate layer may be specifically a mixture of one or more of polyolefin, a modified polymer of polyolefin, polyurethane, or polyester. Further, the polyolefin may be a mixture of one or more of polyethylene, polypropylene, polyvinyl chloride, or polybutylene. The modified polymer of polyolefin may be one or more of an ethylene-acrylic acid modified polymer, a propylene-maleic anhydride grafted modified polymer, or a propylene-acrylic acid modified polymer. Further, a melting point of the insulating substrate layer is greater than or equal to 130° C. (for example, greater than or equal to 135° C., greater than or equal to 140° C., greater than or equal to 150° C., or greater than or equal to) 160° C.

In an example, the conductive hot melt adhesive layer is continuous.

In an example, the conductive hot melt adhesive layer is discontinuous, for example, includes a plurality of coating blocks. In this case, in the first state, electrical conduction does not occur in the conductive hot melt adhesive layer, and the conductive insulating tape exerts an insulation characteristic; in the second state, the conductive hot melt adhesive layer flows to form a continuous layer, so that electrical conduction occurs, and the conductive insulating tape exerts a conductive characteristic.

In an example, an interval between discontinuously disposed coating blocks of the conductive hot melt adhesive layer ranges from 0.1 mm to 100 mm, for example, is 0.1 mm, 1 mm, 5 mm, 10 mm, 20 mm, 30 mm, 40 mm, 50 mm, 60 mm, 70 mm, 80 mm, 90 mm, 100 mm, or a value in a range formed by any two points.

In an example, a total area of the one-sided conductive hot melt adhesive layer accounts for 30-99% of an area of the insulating substrate layer, for example, is 30%, 40%, 50%, 60%, 70%, 80%, 90%, or 99% of the area of the insulating substrate layer.

In an example, a thickness of the conductive hot melt adhesive layer ranges from 1 μm to 100 μm, for example, is 1 μm, 10 μm, 20 μm, 30 μm, 40 μm, 50 μm, 60 μm, 70 μm, 80 μm, 90 μm, 100 μm, or a value in a range formed by any two points. For another example, a thickness of the conductive hot melt adhesive layer ranges from 4 μm to 30 μm.

Preparation of the conductive hot melt adhesive and the conductive insulating tape is not specifically limited, and may be obtained by means of chemical reaction or commercial purchase and mixing depending on a required component.

In an example, the conductive hot melt adhesive is obtained by purchasing components and mixing them (in a heating condition if necessary). For example, various components of a matrix are melted and mixed, and then mixed with components of the conductive filler to obtain the conductive hot melt adhesive.

In another example, the conductive hot melt adhesive is obtained by means of preparation according to a conventional method in the art, for example, prepared by means of an esterification reaction and a polycondensation reaction. For example, first, a matrix raw material is esterified, and then a conductive filler is added for polycondensation under a reduced pressure to obtain a conductive hot melt adhesive.

In a specific implementation, preparation may be performed by using the following method:
(1) performing the first esterification reaction under an action of Sb(AC)₃ catalyst in a protective atmosphere of nitrogen or argon on a long-chain fatty diacid, a medium-chain fatty diacid, and a branched chain diols with 8 or less carbon atoms mixed according to following parts by mass: 20-30: 20-30:15-30, where a reaction temperature is between 190° C. and 210° C., and the reaction is finished when water yield reaches 96% or more of a theoretical amount;
(2) adding 10-15 parts by mass of terephthalic acid, 5-10 parts by mass of dimer acid, 5-8 parts by mass of hexamethylenediamine, 10-15 parts by mass of butanediol, and 5-8 parts by mass of glycerol to the system in step (1), and performing the second esterification reaction at a reaction temperature ranging from 190° C. to 210° C., to obtain polybutylene terephthalate copolyester (PBT copolyester for short); and
(3) adding 10-20 parts by mass of polyolefin, 3-8 parts by mass of thermoplastic elastomer, 1-6 parts by mass of coupling agent, 1-5 parts by mass of heat stabilizer, 10-30 parts by mass of conductive copper powder, 10-30 parts by mass of CNT carbon nanotubes, 1-3 parts by mass of copper oxide powder, and 1-3 parts by mass of titanium carbide into the system in step (2), continuing a polycondensation reaction under a reduced pressure for 30-40 minutes, and discharging after the polycondensation is completed, to obtain the conductive hot melt adhesive.

The preparation method is only an example of the method for preparing the conductive hot melt adhesive in the present disclosure.

The conductive hot melt adhesive in the present disclosure is not limited to the foregoing two preparation methods, and an appropriate preparation method may be correspondingly used when different raw materials are selected, which will not be enumerated herein.

The obtained conductive hot melt adhesive is applied on an insulating substrate, or is cast and co-extruded with an insulating substrate material into a thin film by using a melt extruder, to obtain a conductive insulating tape.

A third aspect of the present disclosure provides a battery, including the conductive hot melt adhesive according to the first aspect.

A fourth aspect of the present disclosure provides a battery, including the conductive insulating tape according to the second aspect.

In an example, the conductive insulating tape is directly in contact with the battery cell by means of a conductive hot melt adhesive layer, and the insulating substrate layer is located on a side, away from the battery cell, of the conductive hot melt adhesive layer. Contact surfaces between the conductive hot melt adhesive layer and the battery cell include contact surfaces that are respectively in contact with the positive electrode component and the negative electrode component, where a conductive hot melt adhesive portion that is in contact with the positive electrode component and a conductive hot melt adhesive portion that is in contact with the negative electrode component are discontinuous, that is, there is a gap between the two contact surfaces.

In an example, the gap ranges from 0.1 mm to 100 mm, for example, is 0.1 μm, 0.5 μm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, or a value in a range formed by any two points.

In an example, the conductive hot melt adhesive layer of the conductive insulating tape is attached to the battery cell, the insulating substrate layer is located on a side, away from the battery cell, of the conductive hot melt adhesive layer, the conductive hot melt adhesive layer is in contact with both the positive electrode component and the negative electrode component, and the conductive hot melt adhesive layer on the insulating substrate layer is discontinuous, and includes several coating blocks.

In an example, an interval between discontinuously disposed conductive hot melt adhesive ranges from 0.1 mm to 100 mm, for example, is 0.1 μm, 0.5 μm, 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, or a value in a range formed by any two points.

In an example, the conductive hot melt adhesive layer of the conductive insulating tape is attached to a top or a tail of the battery cell, the conductive hot melt adhesive is opposite to side edges, on a same side with the conductive hot melt adhesive, of a first electrode plate and a second electrode plate of the battery cell, and the conductive hot melt adhesive layer has a gap with the first electrode plate or the second electrode plate.

In an example, the battery cell is a stacked cell, and the battery cell includes a first electrode plate and a second electrode plate that are stacked. A separator is disposed between the first electrode plate and the second electrode plate, and a foil uncoating region is provided at a tail of each of the first electrode plate and the second electrode plate. The first electrode plate and the second electrode plate are provided at an outermost layer of the battery cell, a conductive hot melt adhesive layer of the conductive insulating tape is attached to an outer side of the foil uncoating region at the tail of the first electrode plate located at the outermost layer, and there is a gap between the conductive hot melt adhesive layer and the foil uncoating region at the tail of the second electrode plate located at the outermost layer.

In an example, the conductive hot melt adhesive layer of the conductive insulating tape is attached to a first soft tab and a second soft tab of the battery cell, and the conductive hot melt adhesive layer is in contact with both the first soft tab and the second soft tab.

In an example, a packaging film for packaging a cell is further included. A first tab and a second tab of the battery protrude from a top sealing edge of the packaging film, a conductive hot melt adhesive layer of the conductive insulating tape is attached to the top sealing edge, and the conductive hot melt adhesive layer is in contact with both the first tab and second tab.

In some optional embodiments, a thickness of the conductive hot melt adhesive layer ranges from 1 μm to 100 μm, for example, is 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, or a value in a range formed by any two points. For another example, a thickness of the conductive hot melt adhesive layer ranges from 4 μm to 30 μm.

The conductive hot melt adhesive in the present disclosure may be applied to a battery such as a secondary lithium-ion battery or a lithium metal battery. A cell in the battery may be a stacked cell or a wound cell. The cell includes a positive electrode component and a negative electrode component. In one use manner, the conductive hot melt adhesive is attached to the insulating substrate layer to form a conductive hot melt adhesive layer, and the conductive hot melt adhesive layer is attached to the cell as an adhesive surface. The conductive hot melt adhesive layer is a layer that is directly bonded and contacted with the cell. In another use manner, the conductive hot melt adhesive (not attached to the insulating substrate layer) is disposed in the battery cell or is used to replace a part of the battery cell. The conductive hot melt adhesive or the conductive hot melt adhesive layer on the conductive insulating tape may be attached to any location of the cell, as long as being disposed close to the positive electrode component and the negative electrode component. A gap is maintained between the positive electrode component and/or the negative electrode component of the conductive hot melt adhesive, or the conductive hot melt adhesive is discontinuously disposed between the positive electrode component and the negative electrode component, so that a conductive connection is not formed between the positive electrode component and the negative electrode component when the conductive hot melt adhesive is in a first state. However, at a high temperature, the conductive hot melt adhesive softens and flows in a second state, so that the conductive hot melt adhesive conducts the positive electrode component and the negative electrode component, thereby implementing discharge of the battery by using the conductive hot melt adhesive.

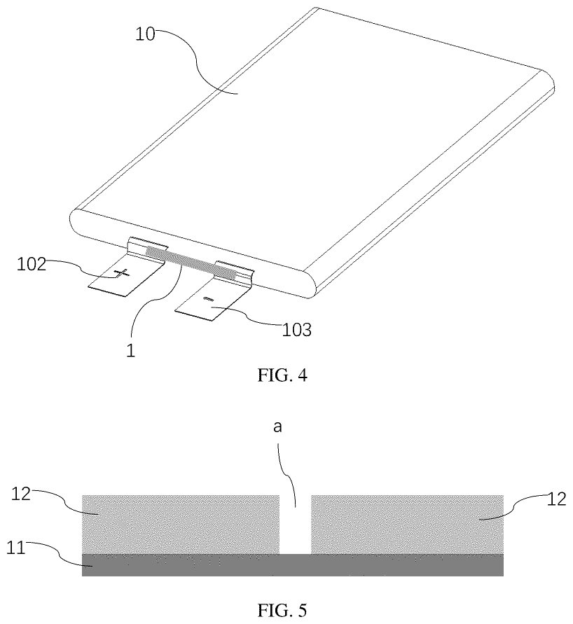

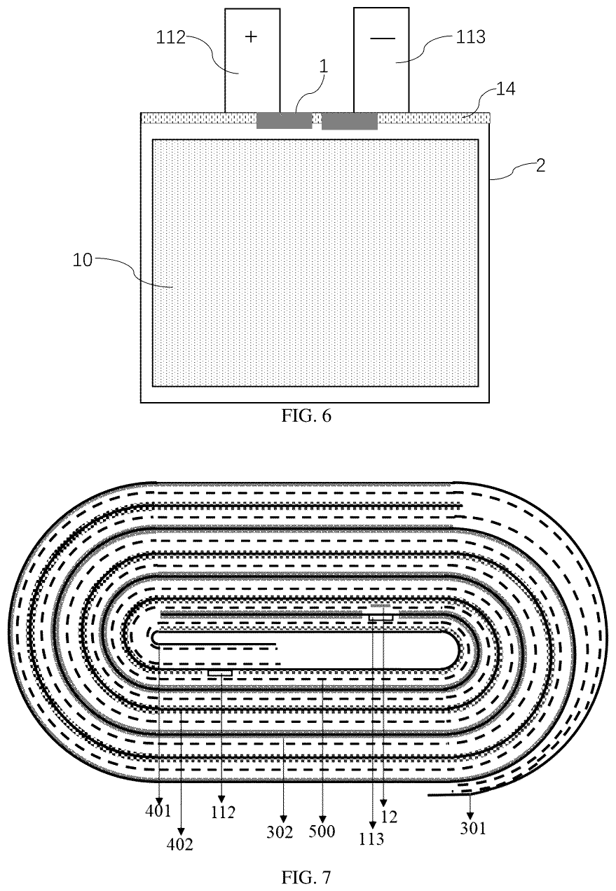

The positive and negative electrode components of the battery may be positive and negative tabs, positive and negative electrode plates, or positive and negative electrode current collectors. For example, the conductive hot melt adhesive or the conductive hot melt adhesive layer on the conductive insulating tape may be disposed close to positive and negative tabs, positive and negative electrode plates, positive and negative electrode current collectors, a tab and an electrode plate with opposite polarities, a tab and a current collector with opposite polarities and a current collector and an electrode plate with opposite polarities. In a specific application, the conductive hot melt adhesive layer on the conductive insulating tape may be attached to a top or a tail of the battery cell, and the conductive hot melt adhesive layer is discontinuous (as shown in FIG. 2); may be attached to a foil uncoating region of an electrode plate at a tail end of the battery cell, and there is a gap between the conductive hot melt adhesive layer and a foil uncoating region at a tail of another electrode plate (as shown in FIG. 3); may be attached to a first soft tab and a second soft tab of the battery cell, the conductive hot melt adhesive layer is in contact with both the first soft tab and the second soft tab, and the conductive hot melt adhesive layer is discontinuous (as shown in FIG. 4); or may be attached to top sealing edge of a packaging film of the battery cell, the conductive hot melt adhesive layer is in contact with both the first tab and the second tab, and the conductive hot melt adhesive layer is discontinuous (as shown in FIG. 6). The conductive hot melt adhesive may be disposed between a positive electrode plate and a negative electrode plate (to replace a partial region on a separator), and the conductive hot melt adhesive is not simultaneously in contact with both the positive electrode plate and the negative electrode plate (as shown in FIG. 7). An interval between discontinuously disposed conductive hot melt adhesive may range from 0.1 mm to 100 mm, and preferably is between 0.5 mm and 10 mm. A gap between the conductive hot melt adhesive and the positive or negative electrode components may range from 0.1 mm to 100 mm, and preferably is between 0.5 mm and 10 mm. This may avoid a short circuit caused by the conductive hot melt adhesive conducting the positive and negative electrode components at normal temperature or when a temperature of the battery is lower than the Vicat softening temperature of the conductive hot melt adhesive. In addition, the positive and negative electrode components of the battery may be conducted through softening and flowing of the conductive hot melt adhesive at high temperature, thereby implementing discharge.

The following further describes the present disclosure by using specific examples. Unless otherwise specified, all reagents, materials, and instruments used in the following description are all conventional reagents, conventional materials, and conventional instruments, all of which are commercially available, and the involved reagents may also be obtained through synthesis by using conventional synthetic methods.

### Preparation Example 1

This preparation example is used to describe an implementation of preparing a conductive hot melt adhesive by using a melt reaction. First, a matrix is added to a melting reaction furnace and a melt solution is stirred evenly, and then a conductive filler is added to the melt solution. After stirring evenly, the conductive hot melt adhesive is obtained.

Specifically, following method is used for preparation:
(1) adding weighed components of a matrix to a melting reaction furnace, and melting and stirring evenly;
(2) placing weighted components of a conductive filler and additives into a container, and stirring evenly, followed by filtering and drying; and
(3) adding the product obtained in step (2) to the melt solution in step (1), and continuously stirring evenly to obtain the conductive hot melt adhesive.

### Preparation Example 2

This preparation example is used to describe an implementation in which the conductive hot melt adhesive is further prepared to obtain a conductive insulating tape. Specifically, following method is used for preparation:

casting the obtained conductive hot melt adhesive and an insulating substrate material into a thin film having a specific thickness at a specific thickness ratio by using a melt extruder, to obtain a conductive hot melt adhesive attached to the insulating substrate layer.

In the following example, a conductive hot melt adhesive is prepared according to the method in Preparation Example 1. A total of 100 parts by weight of a matrix and a conductive filler (specific composition and content are shown in Table 1) are mixed with 5.5 parts by weight of a POE thermoplastic elastomer, 3.5 parts by weight of a silane coupling agent, 3 parts by weight of an organotin heat stabilizer, and 3 parts by weight of a thiobiophenol antioxidant, to obtain the conductive hot melt adhesive. The conductive insulating tape is prepared according to the method in Preparation Example 2, and a thickness of a fixed insulating substrate is 10 μm. Other parameters are shown in Table 2. The obtained conductive hot melt adhesives are numbered with the letter A as the beginning, and the obtained conductive insulating tapes are numbered with the letter B as the beginning (for example, a conductive hot melt adhesive obtained in Example n is denoted as An, and the obtained conductive insulating tape is denoted as Bn).

TABLE 1

| Number of | Matrix | | | Conductive filler | | |
|---|---|---|---|---|---|---|
| conductive | | Average | Parts | | Average | Parts |
| hot melt | | molecular | by | | particle | by |
| adhesive | Component | weight/Da | weight | Component | size/μm | weight |
| A1 | Polypropylene:paraffin:vanillin = | 800 | 20 | Aluminum powder:silver | 23 | 80 |
| | 1:0.5:0.3 | | | powder:conductive | | |
| | | | | carbon black = 1:1:0.5 | | |
| A2 | Propylene-acrylic acid | 15000 | 45 | Silver | 40 | 55 |
| | copolymer:polyurethane:paraffin = | | | powder:alumina:titanium | | |
| | 1:0.5:0.5 | | | nitride:carbon nanotubes = | | |
| | | | | 1:0.3:0.5:0.3 | | |
| A3 | Polyethylene:azobenzene:benzoic | 4000 | 10 | Copper powder:copper | 45 | 90 |
| | acid:POE elastomer = 1:0.5:0.3:0.8 | | | oxide powder:conductive | | |
| | | | | carbon black = 1:0.7:0.3 | | |
| A4 | Polyethylene:polyamide 6:POE | 18000 | 50 | Silver aluminum alloy | 25 | 50 |
| | elastomer:paraffin = 1:0.5:0.5:0.5 | | | powder:zinc | | |
| | | | | powder:graphite:silicon | | |
| | | | | carbide = 1:0.5:0.2:0.4 | | |
| A5 | Polyethylene:polypropylene:poly- | 6000 | 20 | Silver powder:nickel | 10 | 80 |
| | butylene:polyurethane = 1:1:1:0.7 | | | powder:graphene:conductive | | |
| | | | | carbon powder = 1:0.5:0.5:0.4 | | |
| A6 | Polyethylene:polypentene:propylene- | 12000 | 40 | Aluminum powder:carbon | 0.5 | 60 |
| | acrylic acid copolymer = 1:0.5:0.5 | | | nanotubes:conductive | | |
| | | | | carbon powder = 0.5:1:1 | | |

TABLE 2

| Number of | Conductive hot melt adhesive | | | | | | Insulating substrate | |
|---|---|---|---|---|---|---|---|---|
| conductive | | Vicat | Viscosity | Resistance | Area | | | Melting |
| insulating | | softening | at 130° | at 85° C./ | proportion/ | Thickness/ | | point/ |
| tape | No. | temperature/° C. | C./cps | Ω | % | μm | Component | ° C. |
| B1 | A1 | 95 | 4500 | 0.8 | 65 | 30 | Polyethylene | 255 |
| | | | | | | | terephthalate | |
| B2 | A2 | 105 | 5000 | 5 | 55 | 25 | Isotactic | 165 |
| | | | | | | | polypropylene | |
| B3 | A3 | 65 | 6500 | 12 | 45 | 20 | Isotactic | 165 |
| | | | | | | | polypropylene | |
| B4 | A4 | 110 | 3400 | 20 | 70 | 25 | Polyurethane | 170 |
| B5 | A5 | 130 | 7200 | 0.5 | 35 | 15 | Isotactic | 165 |
| | | | | | | | polypropylene | |
| B6 | A6 | 100 | 4300 | 5 | 50 | 6 | Isotactic | 165 |
| | | | | | | | polypropylene | |

The following example group C is used to describe a plurality of application scenarios of a conductive hot melt adhesive and an insulating substrate material. It should be noted that these application manners are merely examples and do not constitute a limitation on the present disclosure.

### Example Group C1

This example group is used to describe a case in which a conductive insulating tape is used in an application scenario shown in FIG. 2.

### Example C1a

The battery in this example includes a wound battery cell, and the wound battery cell includes a positive electrode plate 3 (a first electrode plate), a negative electrode plate 4 (a second electrode plate), and a separator 500 disposed between the positive electrode plate 3 and the negative electrode plate 4. As shown in FIG. 2, in this example, the conductive insulating tape B1 obtained in Example 1 is thermally bonded to a top portion of a wound battery cell (for a battery cell, an end where a tab protrudes from is the top portion, and another end opposite to the end where a tab protrudes from is a tail portion). A conductive hot melt adhesive 12 is opposite to side edges, on a same side with the conductive hot melt adhesive, of the positive electrode plate 3 and the negative electrode plate 4 of the battery cell, and there is a gap between the conductive hot melt adhesive 12 and the positive electrode plate 3 or the negative electrode plate 4. An insulating substrate layer 11 is located on a side, away from the battery cell, of the conductive hot melt adhesive 12. In a first state, because there is a gap between the conductive hot melt adhesive 12 and the positive electrode plate 3 or the negative electrode plate 4 of the battery cell, the conductive hot melt adhesive 12 cannot conduct the positive electrode plate 3 and the negative electrode plate 4, and thus a battery may be prevented from discharging. A capacity of the battery in this example is 5500 mAh and a voltage is 4.55 V.

### Example C1b

In this example, the conductive insulating tape B2 obtained in Example 2 is thermally bonded to a tail portion of a wound battery cell. A conductive hot melt adhesive is opposite to side edges, on a same side with the conductive hot melt adhesive, of a positive electrode plate and a second electrode plate of the battery cell, and there is a gap between the conductive hot melt adhesive and the positive electrode plate or the negative electrode plate. An insulating substrate layer is located on a side, away from the battery cell, of the conductive hot melt adhesive. In a first state, there is a gap between the conductive hot melt adhesive and the positive electrode plate or the negative electrode plate of the battery cell, and thus the positive electrode plate and the negative electrode plate cannot be conducted. A capacity of the battery in this example is 5500 mAh and a voltage is 4.55 V.

The conductive insulating tapes B3-B6 obtained in Examples 3-6 are respectively used in Examples C1c-C1f. An attaching manner of the conductive insulating tape is the same as that in Example C1a, and a capacity size and a voltage system of the battery are the same as those in Example C1a. Details are shown in Table 3.

### Comparative Example 1

The battery in Comparative Example 1 is the same as the battery in Example C1a, but the conductive hot melt adhesive or conductive insulating tape in the present disclosure is not used in the battery in Comparative Example 1, and replaced with a common hot melt adhesive tape (no conductivity is available at any temperature).

### Example Group C2

This example group is used to describe a case in which a conductive insulating tape is used in an application scenario shown in FIG. 3.

### Example C2a

The battery in this example includes a stacked cell, and the stacked cell includes a positive electrode plate 3 and a negative electrode plate 4 that are stacked together. A separator 500 is disposed between the positive electrode plate 3 and the negative electrode plate 4, and both the positive electrode plate 3 and the negative electrode plate 4 have an empty current collector region with no active material coated. The positive electrode plate 3 and the negative electrode plate 4 are provided at an outermost layer of the battery cell. In this embodiment, the conductive insulating tape B1 obtained in Example 1 is attached to an empty current collector at a tail of the stacked cell, sealed with conductive hot melt adhesive. As shown in FIG. 3, in this example, a conductive hot melt adhesive 12 is attached to the outside of an empty positive electrode current collector 301 at a tail of the positive electrode plate 3 located at the outermost layer of the battery cell, and covers (not shown) the outside of an empty negative electrode current collector 401 at a tail of the negative electrode plate 4 at the outermost layer of the battery cell. An insulating substrate layer 11 is located on a side, away from an electrode plate (the battery cell), of the conductive hot melt adhesive 12. There is a gap between the conductive hot melt adhesive 12 and the foil uncoating region of the negative electrode plate 4 located at the outermost layer of the battery cell, and thus in a first state, the conductive hot melt adhesive 12 cannot conduct the positive electrode plate 3 and the negative electrode plate 4. A capacity of the battery in this example is 10000 mAh and a voltage is 4.35 V.

### Example C2b

A battery cell structure in this example is the same as a battery cell structure in Example C1a. A difference lies in that the conductive insulating tape B2 obtained in Example 2 is attached to a foil uncoating region at a tail of a stacked cell for sealing in this example. A conductive hot melt adhesive wraps an aluminum foil uncoating region at a tail of a positive electrode plate and a copper foil uncoating region at a tail of a negative electrode plate, and has a gap with each of the aluminum foil uncoating region and the copper foil uncoating region. An insulating substrate layer is located on a side, away from an electrode plate, of the conductive hot melt adhesive. In a first state, the conductive hot melt adhesive cannot conduct the positive electrode plate and the negative electrode plate. A capacity of the battery in this example is 10000 mAh and a voltage is 4.42 V.

The conductive insulating tapes B3-B6 obtained in Examples 3-6 are respectively used in Examples C2c-Cf. An attaching manner of the conductive insulating tape is the same as that in Example C2b, and a capacity size and a voltage system of the battery are the same as those in Example C2b. Details are shown in Table 3.

### Comparative Example 2

The battery in Comparative Example 2 is the same as the battery in Example C2a, but the conductive hot melt adhesive or conductive insulating tape in the present disclosure is not used in the battery in Comparative Example 2, and replaced with a common hot melt adhesive tape (no conductivity is available at any temperature).

### Comparative Example 3

The battery in Comparative Example 3 is the same as the battery in Example C2b, but the conductive hot melt adhesive or conductive insulating tape in the present disclosure is not used in the battery in Comparative Example 3, and replaced with a common hot melt adhesive tape (no conductivity is available at any temperature).

### Example Group C3

This example group is used to describe a case in which a conductive insulating tape is used in application scenarios shown in FIG. 4 and FIG. 5.

### Example C3a

The battery in this example includes a wound battery cell. In this example, the conductive insulating tape B2 obtained in Example 1 is on a positive soft tab (first soft tab) and a negative soft tab (second soft tab) of the wound battery cell. As shown in FIG. 4, a conductive hot melt adhesive is attached to a positive soft tab 102 and a negative soft tab 103 of the battery cell, the conductive hot melt adhesive is in contact with both the positive soft tab and the negative soft tab, and an insulating substrate layer 11 is located on a side, away from a soft tab, of the conductive hot melt adhesive. As shown in FIG. 5, a conductive hot melt adhesive 12 on the insulating substrate layer 11 is discontinuous, and an interval a of 0.5 mm exists between the discontinuous conductive hot melt adhesive 12. The interval a separates a segment of conductive hot melt adhesive 12 that is in contact with a positive soft tab and a segment of conductive hot melt adhesive 12 that is in contact with a negative soft tab from each other. Therefore, in a first state, the conductive hot melt adhesive 12 cannot conduct the positive soft tab 102 and the negative soft tab 103. A capacity of the battery in this example is 4500 mAh and a voltage is 4.48 V.

The conductive insulating tapes B2-B6 obtained in Examples 2-6 are respectively used in Examples C3b-C3f. An attaching manner of the conductive insulating tape is the same as that in Example C3a, and a capacity size and a voltage system of the battery are the same as those in Example C3a. Details are shown in Table 3.

### Comparative Example 4

The battery in Comparative Example 4 is the same as the battery in Example C3a, but the conductive hot melt adhesive or conductive insulating tape in the present disclosure is not used in the battery in Comparative Example 4, and replaced with a common hot melt adhesive tape (no conductivity is available at any temperature).

### Example Group C4

This example group is used to describe a case in which a conductive insulating tape is used in application scenarios shown in FIG. 5 and FIG. 6.

### Example C4a

In this example, the conductive insulating tape B1 obtained in Example 1 is attached to a positive tab (first tab) and a negative tab (second tab) that protrude from a battery with a film packaged after the cell is packaged by using a packaging film. As shown in FIG. 6, after a wound battery cell is packaged with an aluminum-plastic film, and a positive tab 112 and a negative tab 113 of a battery are led out from a top sealing edge 14 (a sealing edge on a tab leading-out side of a packaging film is the top sealing edge) of the aluminum-plastic film. A conductive hot melt adhesive is attached to the top sealing edge 14 between the positive tab 112 and the negative tab 113, and the conductive hot melt adhesive 12 is in contact with both the positive tab 112 and the negative tab 113. An insulating substrate layer is located on a side, away from the top sealing edge (battery cell), of the conductive hot melt adhesive 12. The conductive hot melt adhesive 12 on the insulating substrate layer is discontinuous, and an interval a of 2 mm exists in the conductive hot melt adhesive 12. Therefore, in a first state, the conductive hot melt adhesive 12 cannot conduct the positive tab 112 and the negative tab 113. A capacity of the battery in this example is 4500 mAh and a voltage is 4.48 V.

The conductive insulating tapes B2-B6 obtained in Examples 2-6 are respectively used in Examples C4b-C4f. An attaching manner of the conductive insulating tape is the same as that in Example C4a, and a capacity size and a voltage system of the battery are the same as those in Example C4a. Details are shown in Table 3.

### Comparative Example 5

The battery in Comparative Example 5 is the same as the battery in Example C4a, but the conductive hot melt adhesive or conductive insulating tape in the present disclosure is not used in the battery in Comparative Example 5, and replaced with a common hot melt adhesive tape (no conductivity is available at any temperature).

### Example Group C5

This example group is used to describe a case in which a conductive insulating tape is used in an application scenario shown in FIG. 7.

### Example C5a

The battery in this embodiment is a winding battery structure. The conductive hot melt adhesive A1 obtained in Example 1 is placed on a surface of a negative electrode active material layer of a negative electrode plate. There is no separator 500 on a surface of a side, away from the negative electrode plate, of a coverage region of the conductive hot melt adhesive A1, and the conductive hot melt adhesive A1 is not in contact with a positive electrode plate on the opposite side. There is a gap between the conductive hot melt adhesive A1 and the positive electrode plate. Therefore, in a first state, the conductive hot melt adhesive A1 cannot conduct the positive electrode plate 3 and the negative electrode plate 4. A capacity of the battery in this example is 6000 mAh and a voltage is 4.5 V.

The conductive hot melt adhesives A2-A6 obtained in Examples 2-6 are respectively used in Examples C5b-C5f. An attaching manner of the conductive hot melt adhesive is the same as that in Example C5a, and a capacity size and a voltage system of the battery are the same as those in Example C5a. Details are shown in Table 3.

### Comparative Example 6

The battery in Comparative Example 6 is the same as the battery in Example C5a, but the conductive hot melt adhesive in the present disclosure is not used in the battery in Comparative Example 6, that is, a separator is complete.

### Test Example

The following tests were performed on batteries in examples and comparative examples, and results obtained are recorded in Table 3.

### (1) High Temperature External Short-Circuit Test

A high-temperature external short-circuit test was performed in accordance with Article 6.2 of GB/T31241-2014, and temperatures of the batteries were monitored. When a temperature of a battery exceeds 150° C. or the battery fires or explodes, it is determined that the test is not passed; otherwise, it is determined that the test is passed, and a maximum temperature of the battery was recorded.

### (2) Overcharge Test

An overcharge test was performed in accordance with Article 6.3 of GB/T31241-2014, and whether fire and explosion occur in a test process of the batteries in each group was monitored. If the fire and explosion occur, it is determined that the test is not passed; if not occur, it is determined that the test is passed.

### (3) Forced Discharge Test

A forced discharge test was performed in accordance with Article 6.4 of GB/T31241-2014, and whether fire and explosion occur in a test process of the batteries in each group was monitored. If the fire and explosion occur, it is determined that the test is not passed; if not occur, it is determined that the test is passed.

### (4) Thermal Abuse Test

A thermal abuse test was performed in accordance with Article 7.8 of GB/T31241-2014, and temperatures of the batteries were monitored. When a battery fires or explodes, it is determined that the test is not passed; otherwise, it is determined that the test is passed, and a maximum temperature of the battery was recorded.

TABLE 3

| | | High temperature external | | | | | |
|---|---|---|---|---|---|---|---|
| | Conductive hot | short-circuit test | | | | Thermal abuse test | |
| | melt adhesive/ | | Maximum | | Forced | | Maximum |
| | conductive | Passed | temperature/ | Overcharge | discharge | Passed | temperature/ |
| Group | insulating tape | or not | ° C. | test | test | or not | ° C. |
| Example C1a | B1 | Passed | 105 | Passed | Passed | Passed | 137 |
| Example C1b | B2 | Passed | 114 | Passed | Passed | Passed | 138 |
| Example C1c | B3 | Passed | 95 | Passed | Passed | Passed | 137 |
| Example C1d | B4 | Passed | 118 | Passed | Passed | Passed | 141 |
| Example C1e | B5 | Passed | 136 | Passed | Passed | Passed | 145 |
| Example C1f | B6 | Passed | 108 | Passed | Passed | Passed | 140 |
| Comparative | / | Not | 224 | Not | Not | Not | 563 |
| Example 1 | | passed | | passed | passed | passed | |
| Example C2a | B1 | Passed | 108 | Passed | Passed | Passed | 138 |
| Example C2b | B2 | Passed | 116 | Passed | Passed | Passed | 139 |
| Example C2c | B3 | Passed | 97 | Passed | Passed | Passed | 138 |
| Example C2d | B4 | Passed | 122 | Passed | Passed | Passed | 145 |
| Example C2e | B5 | Passed | 140 | Passed | Passed | Passed | 149 |
| Example C2f | B6 | Passed | 113 | Passed | Passed | Passed | 139 |
| Comparative | / | Not | 312 | Not | Not | Not | 511 |
| Example 2 | | passed | | passed | passed | passed | |
| Comparative | / | Not | 356 | Not | Not | Not | 571 |
| Example 3 | | passed | | passed | passed | passed | |
| Example C3a | B1 | Passed | 102 | Passed | Passed | Passed | 137 |
| Example C3b | B2 | Passed | 108 | Passed | Passed | Passed | 142 |
| Example C3c | B3 | Passed | 90 | Passed | Passed | Passed | 137 |
| Example C3d | B4 | Passed | 116 | Passed | Passed | Passed | 142 |
| Example C3e | B5 | Passed | 132 | Passed | Passed | Passed | 144 |
| Example C3f | B6 | Passed | 106 | Passed | Passed | Passed | 139 |
| Comparative | / | Not | 217 | Not | Not | Not | 497 |
| Example 4 | | passed | | passed | passed | passed | |
| Example C4a | B1 | Passed | 101 | Passed | Passed | Passed | 138 |
| Example C4b | B2 | Passed | 107 | Passed | Passed | Passed | 139 |
| Example C4c | B3 | Passed | 92 | Passed | Passed | Passed | 137 |
| Example C4d | B4 | Passed | 115 | Passed | Passed | Passed | 140 |
| Example C4e | B5 | Passed | 130 | Passed | Passed | Passed | 145 |
| Example C4f | B6 | Passed | 105 | Passed | Passed | Passed | 144 |
| Comparative | / | Not | 226 | Not | Not | Not | 493 |
| Example 5 | | passed | | passed | passed | passed | |
| Example C5a | A1 | Passed | 112 | Passed | Passed | Passed | 140 |
| Example C5b | A2 | Passed | 120 | Passed | Passed | Passed | 144 |
| Example C5c | A3 | Passed | 98 | Passed | Passed | Passed | 137 |
| Example C5d | A4 | Passed | 125 | Passed | Passed | Passed | 145 |
| Example C5e | A5 | Passed | 142 | Passed | Passed | Passed | 149 |
| Example C5f | A6 | Passed | 115 | Passed | Passed | Passed | 142 |
| Comparative | / | Not | 357 | Not | Not | Not | 556 |
| Example 6 | | passed | | passed | passed | passed | |

It may be learned from the results in Table 3 that the conductive hot melt adhesive of the present disclosure can be implemented in a battery in various manners, so that safety performance of the battery is obviously improved. The reason is that the conductive hot melt adhesive of the present disclosure is arranged between positive and negative electrode components of the battery in a manner of keeping a gap, or the conductive hot melt adhesive is arranged between the positive and negative electrode components of the battery in a discontinuous manner; in a normal state, the conductive hot melt adhesive is similar to a conventional insulating adhesive, failing to conduct the positive and negative electrode components of the battery; however, when the battery encounters conditions such as a large current, over-charging/over-discharging, and thermal abuse, a characteristic of high-temperature softening and flow of the conductive hot melt adhesive may conduct the positive and negative electrode components connected thereto, thereby discharging the battery. In this way, a voltage and energy of the battery can be quickly reduced to a safe threshold, accidents such as fire and explosion caused by thermal runaway of the battery are effectively prevented, and the safety performance of the battery is improved.

The foregoing embodiments are only used to describe rather than limit the technical solutions of the present disclosure. Although the present disclosure is described in detail with reference to the foregoing embodiments, persons of ordinary skill in the art should understand that modifications or equivalent replacements may still be made to a specific implementation of the present disclosure, and any modifications or equivalent replacements without departing from the spirit and scope of the present disclosure shall fall within the scope of the present disclosure.

What is claimed is:

1. A conductive hot melt adhesive, comprising a matrix and a conductive filler,
wherein the matrix is a mixture of one or more of polyolefin, benzoic acid, vanillin, azobenzene, polyester, polyurethane, polyamide, or paraffin, and the conductive filler is at least one of carbon, an elemental metal, an alloy, a metal oxide, or a conductive non-metal compound; and
a Vicat softening temperature of the conductive hot melt adhesive ranges from 60° C. to 130° C., the conductive hot melt adhesive has a first state and a second state, and the conductive hot melt adhesive is solid in the first state and capable of softening and flowing in the second state.

2. The conductive hot melt adhesive according to claim 1, wherein the matrix is a substance capable of being transformed from a solid to a liquid at a temperature ranging from 60° C. to 130° C.

3. The conductive hot melt adhesive according to claim 1, wherein a viscosity of the conductive hot melt adhesive at 130° C. ranges from 2500 cps to 8000 cps; and/or
a resistance of the conductive hot melt adhesive at 85° C. ranges from 0.01Ω to 100Ω.

4. The conductive hot melt adhesive according to claim 1, wherein using a total weight of the conductive hot melt adhesive as a reference, a weight content of the matrix ranges from 5% to 60%, and a weight content of the conductive filler ranges from 40% to 95%; and/or
a weight ratio of the matrix to the conductive filler is (0.05-2):1.

5. The conductive hot melt adhesive according to claim 1, wherein the matrix comprises a combination of polyolefin and polyester in a weight ratio of (1.5-5):1, and a weight proportion of the polyolefin and/or polyester in the matrix is 50% or more; and/or
the matrix comprises a combination of one or more of polyolefin or polyamide, and using a total weight of the matrix as a reference, a weight content of the polyamide ranges from 0% to 20%; and/or
the matrix comprises a combination of polyolefin and polyurethane, and using a total weight of the matrix as a reference, a weight content of the polyurethane ranges from 0% to 30%.

6. The conductive hot melt adhesive according to claim 1, wherein the matrix further comprises paraffin, and using a total weight of the matrix as a reference, a weight content of the paraffin ranges from 0% to 80%; and/or
the matrix further comprises benzoic acid, and using a total weight of the matrix as a reference, a weight content of the benzoic acid ranges from 0% to 50%; and/or
the matrix further comprises vanillin, and using a total weight of the matrix as a reference, a weight content of the vanillin ranges from 0% to 80%; and/or
the matrix further comprises azobenzene, and using a total weight of the matrix as a reference, a weight content of the azobenzene ranges from 0% to 30%.

7. The conductive hot melt adhesive according to claim 1, wherein the matrix is selected from one or more of polyethylene, polypropylene, polybutylene, polypentene, an ethylene-vinyl acetate copolymer, an ethylene-acrylic acid copolymer, a propylene-vinyl acetate copolymer, a propylene-acrylic acid copolymer, a butylene-vinyl acetate copolymer, polyethylene terephthalate (PET), polybutylene terephthalate (PBT), polyarylester, poly(p-benzophenone-butylene terephthalate), polylactic acid polyester, polyamide 6, polyamide 11, polyamide 12, polyurethane, paraffin, benzoic acid, vanillin, or azobenzene.

8. The conductive hot melt adhesive according to claim 1, wherein an average molecular weight of the matrix is in a range from 300 Da to 20000 Da.

9. The conductive hot melt adhesive according to claim 1, wherein the matrix comprises one or more of the following combinations:
a combination of polypropylene and paraffin in a weight ratio of 1:(0.5-0.8);
a combination of propylene-acrylic acid copolymer and polyurethane in a weight ratio of 1:(0.2-0.7);
a combination of polyethylene and vanillin in a weight ratio of 1:(0.5-1.0);
a combination of polypropylene, paraffin, and vanillin in a weight ratio of 1:(0.2-0.8):(0.1-0.5);
a combination of propylene-acrylic acid copolymer, polyurethane, and paraffin in a weight ratio of 1:(0.2-0.8):(0.2-0.8);
a combination of polyethylene, azobenzene, benzoic acid, and POE elastomer in a weight ratio of 1:(0.2-0.8):(0.1-0.5):(0.5-1);
a combination of polyethylene, polyamide 6, POE elastomer, and paraffin in a weight ratio of 1:(0.2-0.8):(0.2-0.8):(0.2-0.8);
a combination of polyethylene, polypropylene, polybutylene, and polyurethane in a weight ratio of 1:(0.8-1.2):(0.8-1.2):(0.5-1); or
a combination of polyethylene, polypentene, propylene-acrylic acid copolymer in a weight ratio of 1:(0.2-0.8):(0.2-0.8).

10. The conductive hot melt adhesive according to claim 1, wherein the carbon comprises one or more of conductive carbon black, carbon nanotubes, graphene, graphite, or graphite nanoparticles; and/or
the elemental metal comprises one or more of gold, silver, platinum, copper, aluminum, nickel, zinc, or tin; and/or
the alloy comprises one or more of brass, white copper, bronze, silver-aluminum alloy, copper-silver alloy, nickel-aluminum alloy, silver-plated copper, silver-plated aluminum, or silver-plated zinc; and/or
the metal oxide comprises one or more metal composite oxides of an aluminum oxide, a copper oxide, a nickel oxide, a zinc oxide, a calcium oxide, or a rare earth metal oxide; and/or
the conductive non-metal compound comprises at least one of a carbon compound, a silicon compound, a nitrogen compound, a selenium compound, or a carbon-nitrogen compound.

11. The conductive hot melt adhesive according to claim 1, wherein the conductive filler comprises a combination of carbon and the elemental metal in a weight ratio of (0.2-5):1; and/or
a sum of weights of the carbon and the elemental metal accounts for 50% or more of the conductive filler.

12. The conductive hot melt adhesive according to claim 11, wherein the conductive filler further comprises a combination of the metal oxide and the conductive non-metal oxide in a weight ratio of (0.2-5):1.

13. The conductive hot melt adhesive according to claim 1, wherein the conductive filler is in a powder form, and an average crystal particle diameter Dv10 meets: 0.01 μm≤Dv10≤50 μm.

14. The conductive hot melt adhesive according to claim 1, wherein the conductive hot melt adhesive further comprises an additive, and the additive comprises one or more of a toughening agent, a coupling agent, a heat stabilizer, an antioxidant, or a surfactant.

15. The conductive hot melt adhesive according to claim 14, wherein a content of the additive ranges from 5 to 50 parts by weight based on 100 parts by weight of a total weight of the matrix and the conductive filler.

16. The conductive hot melt adhesive according to claim 14, wherein the toughening agent comprises one or more of a thermoplastic elastomer, an ethylene propylene rubber, or a nitrile rubber, and a content of the toughening agent ranges from 0.5 to 10 parts by weight based on 100 parts by weight of a total weight of the matrix and the conductive filler; and/or
the coupling agent comprises one or more of a silane coupling agent, a titanate coupling agent, an aluminate coupling agent, a phosphate coupling agent, or a borate coupling agent, and an amount of the coupling agent ranges from 0.5 to 10 parts by weight based on 100 parts by weight of a total weight of the matrix and the conductive filler; and/or
the antioxidant comprises one or more of a thiobiophenol antioxidant, an amine antioxidant, or an organic sulfur antioxidant, and an amount of the antioxidant ranges from 0.5 to 10 parts by weight based on 100 parts by weight of a total weight of the matrix and the conductive filler; and/or
the heat stabilizer comprises one or more of an organotin stabilizer, an organolead stabilizer, or a calcium soap, and an amount of the heat stabilizer ranges from 0.5 to 10 parts by weight based on 100 parts by weight of a total weight of the matrix and the conductive filler; and/or
the surfactant comprises one or more of silicate, phosphate, carboxylate, triethylhexyl phosphate, sodium dodecyl sulfate, methyl pentanol, a cellulose derivative, polyacrylamide, guar gum, fatty acid polyethylene glycol ester, xylene, ethylene glycol, or glycerol, and an amount of the surfactant ranges from 1 to 30 parts by weight based on 100 parts by weight of a total weight of the matrix and the conductive filler.

17. A conductive insulating tape, comprising an insulating substrate layer and a conductive hot melt adhesive layer located on a surface of one or two sides of the insulating substrate layer, wherein the conductive hot melt adhesive layer comprises the conductive hot melt adhesive according to claim 1.

18. The conductive insulating tape according to claim 17, wherein the conductive hot melt adhesive layer comprises a plurality of coating blocks, and an interval between the coating blocks ranges from 0.1 mm to 100 mm.

19. A battery, comprising the conductive hot melt adhesive according to claim 1.

20. The battery according to claim 19, wherein the conductive hot melt adhesive or a conductive hot melt adhesive layer on the conductive insulating tape is attached to one or more of the following locations:
attaching the conductive hot melt adhesive layer on the conductive insulating tape to a top or a tail of a battery cell, wherein the conductive hot melt adhesive layer is discontinuous;
attaching the conductive hot melt adhesive layer on the conductive insulating tape to a foil uncoating region of an electrode plate at a tail end of the battery cell, wherein there is a gap between the conductive hot melt adhesive layer and a foil uncoating region at a tail of another electrode plate;
attaching the conductive hot melt adhesive layer of the conductive insulating tape to a first soft tab and a second soft tab of the battery cell, wherein the conductive hot melt adhesive layer is in contact with both the first soft tab and the second soft tab, and the conductive hot melt adhesive layer is discontinuous;
attaching the conductive hot melt adhesive layer of the conductive insulating tape to top sealing edge of a packaging film of the battery cell, wherein the conductive hot melt adhesive layer is in contact with both a first tab and a second tab, and the conductive hot melt adhesive layer is discontinuous; or
attaching the conductive hot melt adhesive between a positive electrode plate and a negative electrode plate to replace a partial region on a separator, wherein the conductive hot melt adhesive is not simultaneously in contact with both the positive electrode plate and the negative electrode plate.
